(19) United States
(12) Patent Application Publication
(10) Pub. No.: US 2022/0061356 A1
(43) Pub. Date: Mar. 3, 2022

(54) ANIMAL FEED COMPOSITION

(71) Applicant: PROAGNI PTY LTD, Table Top, New South Wales (AU)

(72) Inventors: Robert Bell, Table Top, New South Wales (AU); Fiona Soulsby, Table Top, New South Wales (AU); Lachlan Campbell, Table Top, New South Wales (AU)

(21) Appl. No.: 17/413,875

(22) PCT Filed: Dec. 14, 2018
(86) PCT No.: PCT/AU2018/051345

§ 371 Date: Jun. 14, 2021

(51) Int. Cl. A23K 50/10; A23K 20/174; A23K 20/142; A23K 10/18; A23K 20/20

(52) U.S. Cl. CPC A23K 50/10; A23K 20/174; A23K 10/30; A23K 10/18; A23K 20/30; A23K 20/142

(57) ABSTRACT

The present disclosure relates to compositions, concentrates, supplements and animal feeds for feeding to ruminant animals. The present disclosure further relates to methods of improving feed conversion, resource utilisation, water utilisation in livestock, as well as methods of reducing livestock emissions and reducing antibiotic use in livestock feed, methods of inducing satiety in livestock and methods of preventing lactic acidosis in ruminant animals.

### TECHNICAL FIELD

The present disclosure relates to compositions, concentrates, supplements and animal feeds for feeding to ruminant animals. The present disclosure further relates to methods of improving feed conversion, resource utilisation, and water utilisation in livestock, as well as methods of reducing livestock emissions and reducing antibiotic use in livestock feed, methods of inducing satiety in livestock and methods of preventing lactic acidosis in ruminant animals.

### BACKGROUND

Feed efficiency and rate of gain are important factors in livestock production. Feed efficiency relates to the amount of feed intake required to produce a specified amount of weight gain in an animal. Rate of gain relates to the amount of daily weight gain (frequently referred to as average daily gain, or ADG) on a specified type and/or amount of feed, whether it is forage, grazing and/or grain. Many variables affect these performance criteria, including species, age, genetics, climate, as well as type and amount of feed, forage, grass and supplementation.

Methane (CH₄) is a greenhouse gas produced primarily by methanogenic microbes that are found in natural ecosystems (e.g. wetlands, oceans and lakes) and the gastrointestinal tract of invertebrates and vertebrates, such as termites and ruminants. Anthropogenic greenhouse gas emissions have been increasing rapidly, with the CH₄ concentration in the atmosphere now more than twofold higher than in the early 1800s. Methane is very effective in absorbing solar infrared radiation and has a global warming potential 25 times greater than CO₂. Consequently, its accumulation in the atmosphere contributes considerably to climate change. One of the main sources of anthropogenic CH₄ can be attributed to agricultural activities, including ruminant livestock.

As reported by the United Nations, cattle-rearing generates more global warming greenhouse gases, as measured in CO₂ equivalent, than transportation. In Australia, ruminants are estimated to contribute about 10% of the total greenhouse gas emissions. Ruminants produce CH₄ as a by-product of the anaerobic microbial fermentation of feeds in the rumen and, to a lesser extent, in the large intestine. The ruminal microbial community is highly diverse and composed of bacteria, protozoa, fungi, and bacteriophages that act collectively to ferment ingested organic matter (OM), resulting in CO₂, H₂, volatile fatty acids (VFAs), and formates. Methanogenic archaea present in the rumen use these end-products and produce CH₄. Although the production of CH₄ reduces the partial pressure of H₂, which could otherwise inhibit rumen fermentation, it also reduces the amount of energy and carbon available for formation of VFAs essential for ruminant nutrition. Most of the CH₄ produced in ruminants is exhaled and belched by the animal and represents a loss of up to 12% of gross energy intake.

There remains a need for compositions and methods for improving animal feed conversion and reducing livestock emissions.

### SUMMARY

The present disclosure relates to compositions comprising a mix of ingredients formulated to manipulate ruminant microbial populations and influence fermentation, and therefore influence overall volumes of energy produced in ruminant digestion. Feeding ruminant animals the compositions results in one or more of improved average daily gain, reduced feed conversion, and reduced methane emissions. Feeding the compositions to ruminant animals may also remove the need for ingested antibiotics and ionophores on grain feeding.

Accordingly, the present disclosure provides a composition for ruminant animals comprising:
i) at least one vitamin selected from Vitamin A, Vitamin D3, B Group Vitamin and Vitamin E;
ii) at least one trace element selected from Cobalt, Iodine, Manganese, Selenium and Zinc;
iii) at least one sulphur containing amino acid selected from methionine, methionine hydroxy analog, lysine, homocysteine and cysteine;
iv) at least one prebiotic selected from an oligosaccharide prebiotic and a polysaccharide prebiotic; and
v) at least one plant extract.

In some embodiments, the B Group Vitamin is Vitamin B1.

In some embodiments, the Iodine is in the form of potassium iodide.

In some embodiments, the composition comprises at least two Vitamins selected from Vitamin A, Vitamin D3, B Group Vitamin and Vitamin E. In another embodiment, the composition comprises at least three Vitamins selected from Vitamin A, Vitamin D3, B Group Vitamin and Vitamin E.

In some embodiments, the composition comprises at least two prebiotics selected from an oligosaccharide prebiotic and a polysaccharide prebiotic.

In some embodiments, the oligosaccharide prebiotic comprises mannan-oligosaccharides (MOS).

In some embodiments, the polysaccharide prebiotic comprises β-(1,3 and 1,6)-poly-D-glucose.

In some embodiments, the at least one plant extract is selected from Coriandum sativum extract, Daucus carota extract, Myristica fragrans extract, Aniba rosaeodora extract, Apium graveolens extract, Boswellia carterii extract, Cananga odorata extract, Cedrus atlantica extract, Citrus aurantifolia extract, Citrus aurantium extract, Citrus aurantium var. bergamia extract, Citrus limon extract, Citrus x paradisi extract, Citrus reticulata var. madurensis extract, Commiphora myrrha extract, Coriandrum sativum extract, Cucurbita pepo extract, Cupressus sempervirens extract, Cymbopogon citratus extract, Cymbopogon martini extract, Cymbopogon nardus extract, Daucus carota extract, Eucalyptus polybractea extract, Foeniculum vulgare extract, Gaultheria procumbens extract, Juniperus communis extract, Lavandula angustifolia extract, Macadamia integrifolia extract, Melaleuca alternifolia extract, Melaleuca cajuputi extract, Melaleuca quinquenervia extract, Mentha x piperita extract, Mentha spicata extract, Ocimum basilicum extract, Oenothera biennis extract, Origanum majorana extract, Origanum vulgare extract, Pelargonium graveolens extract, Pimpinella anisum extract, Pimenta racemose extract, Pinus sylvestris extract, Piper nigrum extract, Pogostemon patchouli extract, Prunus armeniaca extract, Prunus dulcis extract, Rosmarinus officinalis extract, Salvia officinalis extract, Salvia sclarea extract, Santalum album extract, Syzygium aromaticum extract, Thymus vulgaris extract, and Vetiveria zizanioides extract.

In one embodiment, the composition comprises at least two plant extracts.

In one embodiment, the composition comprises at least three plant extracts.

In one particular embodiment, the plant extract is an essential oil.

In some embodiments, the composition further comprises a dust control agent and/or a carrier.

In some embodiments, the dust control agent is present in the composition in an amount of about 5-10 g/kg. In particular embodiments, the dust control agent is present in the composition at about 5, 6, 7, 8, 9, or 10 g/kg.

In some embodiments, the carrier is present in the composition at about 50-100 g/kg. In particular embodiments, the carrier is present in the composition at about 50, 55, 60, 65, 70, 75, 80, 85, 90, 95, or 100 g/kg.

In one embodiment, the carrier is an inert plant-based product.

In some embodiment, the carrier is selected from wheat pollard and rice hull.

In one embodiment, the dust control agent is a mineral oil. For example, the mineral oil may be white mineral oil.

In some embodiments, the composition comprises 3-7 MIU/kg Vitamin A, 0.2-0.6 MIU/kg Vitamin D3, 50-100 g/kg Vitamin E, and/or 6-10 g/kg Vitamin B1.

In some embodiments, the composition comprises 8-12 g/kg Copper, 0.05-0.2 g/kg Cobalt, 0.25-0.75 g/kg Iodine, 6-10 g/kg Manganese, 0.02-0.05 g/kg Selenium, and/or 14-18 g/kg Zinc.

In one embodiment, the composition comprises 150-500 g/kg Methionine or Methionine hydroxy analog.

In some embodiments, the composition comprises 30-40 g/kg mannan-oligosaccharides (MOS) and β-(1,3 and 1,6)-poly-D-glucose.

In some embodiments, the composition comprises Vitamin A, Vitamin D3, Vitamin B1, Vitamin E, Copper, Cobalt, Iodine, Manganese, Selenium, Zinc, Methionine, mannan-oligosaccharides (MOS) and β-(1,3 and 1,6)-poly-D-glucose.

In one embodiment, the composition comprises about 10-60 g/kg of Coriandum sativum extract, Daucus carota extract and/or Myristica fragrans extract.

In another embodiment, the composition comprises about 50-60 g/kg of Coriandum sativum extract, Daucus carota extract and/or Myristica fragrans extract.

In one embodiment, the composition comprises about 60 g/kg of plant extract in total.

In some embodiments, the composition is prepared in the form of a liquid, prill, dry lick, pellets or meal.

In some embodiments, the composition does not contain antibiotics and/or ionophores.

The present disclosure further provides a nutritional supplement for feeding to ruminant animals comprising the composition as described herein.

In some embodiments, the supplement comprises one or more ingredients selected from copper, magnesium oxide, potassium chloride, sulphur, sodium chloride, lime, canola oil, canola meal, wheat, and rice hull.

In some embodiments, the composition or supplement comprises one or more of a protein source, roughage, a buffer, and/or additional minerals.

In some embodiments, the composition or nutritional supplement is for feeding to ruminant animals in a feedlot, ruminant animals receiving intensive finishing nutrition and/or supplemental feeding in extensive grazing.

The present disclosure further provides an animal feed comprising the composition as described herein, or the nutritional supplement as described herein.

In some embodiments, the feed comprises the composition or nutritional supplement of any one of claims mixed with cereal grain rations and/or provided as part of dietary supplementation.

In some embodiments, the animal feed is a full feed ration, for example a full feed ration suitable for consumption by ruminant livestock.

The present disclosure further provides a method of improving the feed conversion, feed efficiency, resource utilisation and/or water utilization of a ruminant animal, the method comprising feeding the composition as described herein, the nutritional supplement as described herein, or the animal feed as described herein to the ruminant animal.

The present disclosure further provides a method of reducing ruminant animal methane and/or nitrous oxide emissions, the method comprising feeding the composition as described herein, the nutritional supplement as described herein, or the animal feed as described herein to the ruminant animal.

The present disclosure further provides a method of inducing satiety in a ruminant animal, the method comprising feeding the composition as described herein, the nutritional supplement as described herein, or the animal feed as described herein to the ruminant animal.

The present disclosure further provides a method of controlling the food intake of a ruminant animal, the method comprising feeding the composition as described herein, the nutritional supplement as described herein, or the animal feed as described herein to the ruminant animal.

The present disclosure further provides a method of improving ammonia retention in the rumen of a ruminant animal, the method comprising feeding the composition as described herein, the nutritional supplement as described herein, or the animal feed as described herein to the ruminant animal.

The present disclosure further provides a method of reducing the risk of a ruminant animal developing ruminal acidosis, the method comprising feeding the composition as described herein, the nutritional supplement as described herein, or the animal feed as described herein to the ruminant animal.

The present disclosure further provides a method of preventing ruminal acidosis in a ruminant animal, the method comprising feeding the composition as described herein, the nutritional supplement as described herein, or the animal feed as described herein to the ruminant animal.

The present disclosure further provides a method of reducing or eliminating the use of antibiotics and/or ionophores in ruminant livestock production, the method comprising feeding the ruminant livestock an animal feed comprising the composition as described herein, the nutritional supplement as described herein and/or the animal feed as described herein, wherein the animal feed fed to the ruminant livestock contains a reduced amount of antibiotic and/or ionophore, or the animal feed does not contain an antibiotic and/or ionophore.

In some embodiments, the reduced amount of antibiotic and/or ionophore is less than the recommended dose of antibiotic and/or ionophore.

In some embodiments, the ruminant animal is undergoing induction to feedlot ration.

In some embodiments, the method comprises formulating the composition as a mineral concentrate, liquid, extrusion, or prill, and feeding the composition to the ruminant animal at a rate of about 0.5 to about 3 grams per kg dry matter intake per day.

In one embodiment, the ruminant animal is selected from cattle, sheep, goats and deer.

In one particular embodiment, the ruminant animal is a sheep and the method comprises feeding the sheep about 0.5 to about 3 grams per kg dry matter intake per day.

In another embodiment, the ruminant animal is cattle and the method comprises feeding the cattle about 0.5 to about 3 grams per kg dry matter intake per day.

In yet another embodiment, the method comprises formulating the composition with a bulking agent to form a mineral lick or pellet, and feeding the composition to the ruminant animal at a rate of about 20 grams to about 650 grams per head per day.

In one embodiment, the ruminant animal is selected from cattle and sheep.

In some embodiments, the ruminant animal is a sheep and the method comprises feeding the sheep at a rate of about 20 grams to about 60 grams per head per day

In some embodiments, the ruminant animal is cattle and the method comprises feeding the cattle at a rate of about 60 to 650 grams per head per day.

The present disclosure further provides use of the composition as described herein, or the nutritional supplement as described herein as a supplement for addition to livestock full feed ration.

The present disclosure further provides use of the composition as described herein, or the nutritional supplement as described herein for improving the feed conversion, resource utilisation and/or water utilization of a ruminant animal.

The present disclosure further provides the use of the composition as described herein, or the nutritional supplement as described herein for reducing ruminant animal methane and/or nitrous oxide emissions, for inducing satiety in a ruminant animal, for controlling the food intake of a ruminant animal, and/or for improving ammonia retention in the rumen of a ruminant animal.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The invention is hereinafter described by way of the following non-limiting Examples and with reference to the accompanying figures.

### BRIEF DESCRIPTION OF THE FIGURES

FIG. 1. Intraruminal pH in treatment group animals versus control group animals.

FIG. 2. Average daily gain in control vs treatment animals.

FIG. 3. Feed efficiency in control vs treatment animals.

FIG. 4. Average minutes per day below pH 6 in control versus treatment animals.

### DESCRIPTION OF EMBODIMENTS

### General Techniques and Definitions

Unless specifically defined otherwise, technical and scientific terms used herein shall be taken to have the same meaning as commonly understood by one of ordinary skill in the art (e.g., in animal nutrition, feed formulation, livestock management).

As used herein, the singular forms of “a”, “and” and “the” include plural forms of these words, unless the context clearly dictates otherwise.

The term “and/or”, e.g., “X and/or Y” shall be understood to mean either “X and Y” or “X or Y” and shall be taken to provide explicit support for both meanings or for either meaning.

As used herein, the terms “preventing”, “prevent”, or “prevention” include administering an effective amount of a composition, supplement or feed to a ruminant animal sufficient to stop or hinder the development of at least one symptom of a disease or condition, for example such as ruminal acidosis.

The term “about” is used herein to mean approximately. When the term “about” is used in conjunction with a numerical range, it modifies that range by extending the boundaries above and below the recited numerical values. In general, the term “about” is used herein to modify a numerical value above and below the stated value by 10%, up or down (higher or lower).

### Compositions

As understood in the art, ruminants are mammals that digest plant-based food by chewing food multiple times. Ruminants acquire nutrients by a process where food is initially chewed, swallowed, partially softened, regurgitated, chewed again, and then digested. Ruminants include cattle, goats, sheep, giraffes, yaks, deer, antelope, and other related animals.

The compositions and methods described herein are for manipulating ruminant microbial populations in order to influence fermentation, and therefore influence overall volumes of energy produced in ruminant digestion. Feeding ruminant animals the compositions results in one or more of improved average daily gain, reduced feed conversion, and reduced methane emissions. Feeding the compositions to ruminant animals may also remove the need for ingested antibiotics and ionophores on grain feeding.

The composition described herein are formulated such that with the addition of a bulking agent, and optionally further ingredients, they may be used as a nutritional supplement for ruminant animals. Alternatively, the composition or the nutritional supplement may be blended into a full ration animal feed.

For example, the composition described herein may be prepared by, or shipped to, an animal feed manufacturer. The composition may then be formulated into a nutritional supplement for ruminant animals by the addition of further ingredients including a bulking agent (for example, canola meal, wheat and/or rice hulls) and optionally additional minerals and ingredients, such as, for example copper, acid buffer, magnesium oxide, potassium chloride, sulphur, salt, lime, and/or vegetable oil.

In some embodiments, the composition described herein or the nutritional supplement may be formulated into an animal feed, i.e. a full feed ration, comprising further ingredients such as wheat, barley, lupins, chickpeas, hay and/or molasses. As would be understood in the art, animal feeds will typically be nutritionally complete.

### Vitamins

The composition as described herein comprises one or more vitamins selected from Vitamin A, Vitamin D3, B Group Vitamin and Vitamin E.

Vitamin A is a fat soluble vitamin that plays an essential role in cellular membrane integrity and immunity. Vitamin A influences organ development, cell proliferation and cell differentiation. In some embodiments, the composition may comprise Vitamin A in an amount of about 3-7 MIU/kg, for example about 3, 3.5, 4, 4.5, 5, 5.5, 6, 6.5 or 7 MIU/kg.

The primary function of Vitamin D is to elevate plasma calcium and phosphorus to a level that will support normal mineralization of bone as well as other body functions. Vitamin D also enhances magnesium absorption. In some embodiments, the composition may comprise Vitamin D in an amount of about 0.2-0.6 MIU/kg, for example about 0.2. 0.25, 0.3, 0.35, 0.4, 0.45, 0.5, 0.55, or 0.6 MIU/kg. In one embodiment, the Vitamin D is Vitamin D3.

Vitamin E has been shown to be essential for the integrity and optimum function of reproductive, circulatory, nervous and immune systems. Vitamin E is highly active as an antioxidant. In some embodiments, the compositions may comprise an amount of Vitamin E from about 50-100 g/kg, for example about 50, 55, 60, 65, 70, 75, 80, 85, 90, 95, or 100 g/kg.

B Group Vitamins are a class of water-soluble vitamins that play important roles in cell metabolism. Though these vitamins share similar names, they are chemically distinct compounds that often coexist in the same foods. In general, dietary supplements containing all eight are referred to as a vitamin B complex. Individual B vitamin supplements are referred to by the specific number or name of each vitamin. B Group Vitamins include Vitamin B1 (thiamine), B2 (riboflavin), B3 (nicotinamide), B5 (pantothenic acid), B6 (pyridoxine), B7 (biotin), B9 (folate), B12 (cobalamins). In one embodiment, the B Group Vitamin may be Vitamin B1. Vitamin B1 (thiamine) plays an important role in glucose metabolism (Krebs cycle), Thiamin requirement rises as consumption of carbohydrates rises. When dietary thiamin is deficient, body reserves are depleted more rapidly in animals fed a high carbohydrate diet than in those fed a diet high in fat and protein. In some embodiments, the B Group Vitamin is present in the composition in an amount of about 6-10 g/kg, for example about 6, 6.5, 7, 7.5, 8, 8.5, 9, 9.5, or 10 g/kg.

### Trace Elements

The compositions described herein comprise one or more trace elements, such as, for example, trace elements selected from Copper, Cobalt, Iodine, Manganese, Selenium and Zinc. Copper is a metalloenzyme that is heavily involved with energy metabolisation, nervous system function, bone formation and haemoglobin production. Delivered in a chelated form, protects the mineral from antagonists, allowing it to be more efficiently absorbed once reaching the small intestine. The result is greater bioavailability and digestive tract stability. In some embodiments, copper is present in the composition at about 8-12 g/kg, for example about 8, 8.5, 9, 9.5, 10, 10.5, 11, 11.5, or 12 g/kg.

Cobalt is used by rumen microbes to synthesise B12. Vitamin B12 is an essential part of several enzyme systems that carry out a number of basic metabolic functions. Most reactions involve transfer or synthesis of one-carbon units, such as methyl groups. Vitamin B12 is metabolically related to other essential nutrients, such as choline, methionine and folic acid. Although the most important tasks of vitamin B12 concern metabolism of nucleic acids and proteins, it also functions in metabolism of fats and carbohydrates. A summary of vitamin B12 functions include: (a) purine and pyrimidine synthesis; (b) transfer of methyl groups; (c) formation of proteins from amino acids; and (d) carbohydrate and fat metabolism. General functions of vitamin B12 are to promote red blood cell synthesis and to maintain nervous system integrity, which are functions noticeably affected in the deficient state. The primary role of vitamin B12 is as an essential cofactor for the enzymes methionine synthase and methylmalonyl-CoA mutase. Methionine synthase effects the transfer of a methyl group from folic acid (N5-methyltetrahydrofolate) to homocysteine, forming methionine. Therefore, a vitamin B12 deficiency reduces methionine supply and metabolic recycling of methyl groups. In some embodiments, the cobalt is present in the composition at about 0.05-0.2 g/kg, for example about 0.05, 0.1, 0.15, or 0.2 g/kg.

Iodine is important in the synthesis of the thyroid hormones, thyroxine (T4) and triiodothyronine (T3), that regulate energy metabolism in animals. The thyroid hormones are responsible for setting the basal metabolic rate that is a component of the energy needed for maintenance of the body. In some embodiments, iodine is present in the composition at about 0.25-0.75 g/kg, for example about 0.25, 0.30, 0.35, 0.40, 0.45, 0.5, 0.55, 0.6, 0.65, 0.70, or 0.75 g/kg.

The primary role of Manganese is as an enzyme activator. Manganese is involved in activating the enzymes responsible for the production of mucopolysaccharides and glycoproteins which form the organic matrix of bone and cartilage. In some embodiments, the manganese is present in the composition at about 6-10 g/kg, for example about 6, 6.5, 7, 7.5, 8, 8.5, 9, 9.5, or 10 g/kg.

Selenium is an integral component of the glutathione peroxidase enzyme which works as a cellular antioxidant. The major role of this enzyme is to protect cellular membranes from damage by converting hydrogen peroxide to water. Hydrogen peroxide and other intermediates of cellular reduction pathways can damage cellular membranes, disrupt cellular function and may negatively impact animal health. In some embodiments, the selenium is present in the composition at about 0.02-0.05 g/kg, for example about 0.02, 0.025, 0.03, 0.035, 0.04, 0.045, or 0.05 g/kg.

Zinc is an essential nutrient for animals, functioning largely or entirely in enzyme systems and being involved in protein synthesis, carbohydrate metabolism, and many other biochemical reactions. Zinc has a close relationship with Beta carotene for the formation, storage and distribution of vitamin A. In some embodiments, zinc is present in the composition at about 14-18 g/kg, for examples about 14, 14.5, 15, 15.5, 16, 16.5, 17, 17.5, or 18 g/kg.

### Sulfur-Containing Amino Acids (Methionine and Methionine Analogs)

Microorganism in the rumen degrade nutrients to produce volatile fatty acids and synthesize microbial protein as an energy and protein supply for the ruminant. The ruminants establish a symbiotic relationship with rumen microorganism. The ruminant provides nutrients and the optimal environment conditions and the microbes degrade the feedstuffs and generate volatile fatty acids as an energy source and synthesize microbial protein as a protein source for the ruminant. Rumen microbial protein represents the major source of amino acids to the ruminant animal. Microbial protein can supply 70%-100% of amino acids the ruminant. High microbial protein production can decrease the need to supply rumen degradable protein. Microbes that are produced in the rumen and then passed down the digestive tract may supply 60-80% of all protein requirements.

Methionine and cysteine are the two primary sulfur-containing amino acids. Methionine is an essential amino acid, obtained by dietary intake while cysteine is non-essential and a metabolite of methionine metabolism.

It was demonstrated in 1973 that when methionine (sulphur containing amino acid) was available freely in diets that bacterial mass increased, and that bacterial mass did not increase when methionine was limiting. While inorganic sulphur contributed to microorganism biomass overall, methionine hydroxyl analogue (MHA) out-yielded total microbial mass considerably. By suppling an increased level of microbial synthesised protein there is a downstream knock on effect which will have positive consequential impacts on appetite (satiety), energy utilisation, and vitamin production which all leads to increased performance.

In some embodiments, the compositions described herein may comprise a sulphur-containing amino acid or analogue selected from methionine and/or MHA. In some embodiments, the methionine or MHA is present in the composition at about 100-500 g/kg, for example about 100, 150, 200, 250, 300, 350, 400, 450, or 500 g/kg.

### Prebiotics

A prebiotic is a non-digestible substance that preferentially stimulates growth of beneficial bacteria. Most prebiotics are fermentable carbohydrates: examples include oligosaccharides, galactans and β-glucans, obtainable from various plant and microbial sources. Specific examples include mannan-oligosaccharides (MOS), β-(1,3 and 1,6)-poly-D-glucose, arabinogalactan, fructooligosaccharide (FOS) and inulin, a polysaccharide that yields FOS.

In some embodiments, the composition as described herein comprises a prebiotic selected from mannan-oligosaccharides (MOS) and β-(1,3 and 1,6)-poly-D-glucose, or a combination of mannan-oligosaccharides (MOS) and β-(1,3 and 1,6)-poly-D-glucose.

In some embodiments, the prebiotic is present in the composition at about 30-40 g/kg, for example about 30, 31, 32, 33, 34, 35, 36, 37, 38, 39, or 40 g/kg.

### Plant Extracts

In some embodiments, the at least one plant extract is selected from Coriandum sativum (coriander) extract, Daucus carota (carrot seed) extract, Myristica fragrans extract, Aniba rosaeodora (rosewood) extract, Apium graveolens (celery seed) extract, Boswellia carterii (frankincense) extract, Cananga odorata (ylang ylang) extract, Cedrus atlantica (cedarwood) extract, Citrus aurantifolia (lime) extract, Citrus aurantium (orange; petigrain) extract, Citrus aurantium var. bergamia (bergamot) extract, Citrus limon (lemon) extract, Citrus x paradisi (grapefruit) extract, Citrus reticulata var. madurensis (mandarin) extract, Commiphora myrrha (myrrh) extract, Cucurbita pepo (pumpkin) extract, Cupressus sempervirens (cypress) extract, Cymbopogon citratus (lemongrass) extract, Cymbopogon martini (palmarosa) extract, Cymbopogon nardus (citronella) extract, Eucalyptus polybractea (Eucalyptus) extract, Foeniculum vulgare (fennel) extract, Gaultheria procumbens (wintergreen) extract, Juniperus communis (juniper) extract, Lavandula angustifolia (French lavender) extract, Macadamia integrifolia (Macadamia) extract, Melaleuca alternifolia (tea tree) extract, Melaleuca cajuputi (cajuput) extract, Melaleuca quinquenervia (niaouli) extract, Mentha x piperita (peppermint) extract, Mentha spicata (spearmint) extract, Ocimum basilicum (basil) extract, Oenothera biennis (evening primrose) extract, Origanum majorana (marjoram) extract, Origanum vulgare (oregano) extract, Pelargonium graveolens (geranium) extract, Pimpinella anisum (aniseed) extract, Pimenta racemose (bay) extract, Pinus sylvestris (pine) extract, Piper nigrum (black pepper) extract, Pogostemon patchouli (patchouli) extract, Prunus armeniaca (apricot kernel) extract, Prunus dulcis (sweet almond) extract, Rosmarinus officinalis (rosemary) extract, Salvia officinalis (sage) extract, Salvia sclarea (clary sage) extract, Santalum album (sandalwood) extract, Syzygium aromaticum (clove) extract, Thymus vulgaris (thyme) extract, Vetiveria zizanioides (vetiver) extract, and Zingiber officinale (ginger) extract.

In some embodiments, the plant extract is present in the composition at about 10-60 g/kg, for example about 10, 15, 20, 25, 30, 35, 40, 45, 50, 55 or 60 g/kg.

### Improving Feed Conversion

The present disclosure provides methods of improving feed conversion or feed efficiency of ruminant animals. Feed conversion (or feed conversion ratio or feed conversion rate) is a measure of the efficiency with which the bodies of livestock convert animal feed into the desired output. For example, for dairy cows the desired output is milk, whereas in animals raised for meat, such as beef cattle, the output is meat, or the body mass of the animal. Feed conversion is the mass of the input divided by the output. In contrast, feed efficiency is the output divided by the input (i.e. the inverse of feed conversion ratio).

In the present Examples, feeding ruminant animals with the compositions described herein resulted in improved feed efficiency, or increased feed conversion. Accordingly, the present disclosure provides a method of increasing feed conversion or improving feed efficiency in a ruminant animal, the method comprising feeding the ruminant animal the composition, nutritional supplement and/or animal feed as described herein.

Reducing Ruminant Animal Methane and/or Nitrous Oxide Emissions

When cattle and sheep digest feed, between 2-10 per cent of the feed energy they consume is lost in the form of methane gas. This is caused by the activity of micro-organisms that naturally live in the animals' stomach (rumen) and assist with digestion. The methane gas (CH₄) is belched out by the animal and into the atmosphere. Simply put, they are ‘leaking’ feed energy, rather than converting it to muscle. Methane is also a potent greenhouse gas and in Australia about 10 per cent of all greenhouse gas emissions and two thirds of agricultural emissions come from methane produced by cattle and sheep. In addition to methane, livestock also emit nitrous oxide (N₂O).

By feeding ruminant animals the composition, nutritional supplement and/or the animal feed as described herein, methane and nitrous oxide emissions from the ruminant animals are reduced compared to feeding the ruminant animals conventional livestock feed or full reed ration.

### Inducing Satiety/Controlling Feed Intake

As used herein, “satiety” refers to satisfaction of the need for nutrition and the extinguishment of the sensation of hunger, which is often described as “feeling full”. The satiety response refers to behavioural characteristics observed to be consistent with having consumed a sufficient amount of food, such as an abrupt or a tapered down cessation of eating. However, the biological mechanisms which lead to the satiety response are often triggered in a gradual or delayed manner, such that they are usually out of phase with the amount of food taken in by the animal prior to cessation, which results in the animal consuming more nutritional content than is appropriate or most efficient. Satiety inducing agents produce an accelerated onset of the satiety response, i.e., animal feed compositions containing satiety inducing agents will trigger the satiety response at an earlier point in time than would a similar animal feed composition without the satiety inducing agent.

The composition, nutritional supplement and animal feed of the present disclosure contains ingredients, for example methionine (or methionine hydroxyl analogue) which is typically one of the first limiting amino acids in ruminant animal nutrition. By providing an abundance of methionine, it is believed that the drivers that increase dietary intake can be suppressed in ruminant animal. This results in a lower feed intake than expected.

In addition, it is believed the ingredients in the compositions, nutritional supplements and animal feeds described herein are altering the ratio of volatile fatty acids (VFA) in the favour of propionate. Propionate is transported through the rumen wall, into the blood stream and taken up by the liver. The liver uses propionate as a major fuel source to generate glucose. Increased absorption of propionate by the liver, and subsequent metabolising of the propionate to glucose results in production of satiety hormones.

Accordingly, by increasing levels of both methionine and propionate, the total dietary demand is decreased, thus result in improvement in total feed efficiency in ruminant animals.

### Ammonia Retention

By means of microbes within the rumen digestive system, most of the energy and nutrients needed by the ruminant are obtained from the feed. Nitrogen containing materials, which may be natural proteins or non-protein sources such as urea, may be broken down and converted into amino acids and proteins by the microorganisms of the rumen. Both urea and natural protein are broken down by the microorganisms in the rumen to ammonia and carbon fragments, and are thereafter reconstituted, together with carbohydrate degradation products, to form amino acids. The amino acids may be used to build protein that may subsequently be used by the host animal. The carbohydrate degradation process provides energy for the amino acid reconstitution process.

However, urea may not be efficiently used by the host animal. In the rumen, via urease, urea may be converted into ammonia at a very rapid rate, generally, at a rate in excess of the rate at which the urea can be converted into useful products by the microorganisms. Any leftover ammonia may be converted back into urea to be expelled with urine, or may accumulate to toxic levels in the animal. Urea expelled in the urine may be converted to ammonia on the ground by contact with urease often found in the faeces or soil. In the air, ammonia can combine with other compounds to form ammonium nitrate and ammonium sulfate, which are fine particulates. These particulates are of concern for human health and are regulated under the Clean Air Act. Therefore, regulating the production of ammonia from urea to provide an optimal concentration of ammonia in the digestive system and minimizing the release of ammonia from animal feeding operations is desirable.

Without wishing to be bound by theory, it is believed the compositions, nutritional supplement and animal feed described herein act to manipulate microorganisms in the rumen, thus manipulating fermentation to produce a higher amount of propionate than other volatile fatty acids. As a consequence there is a lowering in the cross-ruminal wall transfer of ammonia, therefore delivering improved production outcomes due to decreasing the detoxification demand on the liver.

Reduction or Removal of Antibiotics from Animal Feed

Certain antibiotics, when given in low, sub-therapeutic doses, are known to improve feed conversion efficiency (more output, such as muscle or milk, for a given amount of feed) and may promote greater growth, most likely by affecting gut flora. Some of these antibiotics include ionophores. Drugs used to increase feed conversion ratio and weight gain in livestock include bacitracin, bamberycin, carbadox, laidlomycin, lasalocid, monensin, neomycin, penicillin, roxarsone, salinomycin, tylosin and virginiamycin.

Use of antibiotics for livestock greatly exceeds the uses for humans. Although data collection on antibiotic use in some regions is poorly documented, it is estimated that global veterinary consumption of antibiotics in 2013 was around 131,000 tonnes, around 70-80% of total antibiotic consumption.

The use of antibiotics in livestock is believed to pose a significant threat to the effectiveness of antibiotic medicines for human therapeutic use. The UN have issued extensive guidelines on the use of antibiotics in livestock and published a strong recommendation for overall reduction in the use of medically-important antibiotics in livestock production.

As described herein, feeding ruminant livestock the composition, nutritional supplement and/or animal feed described herein results in increased feed conversion without the addition of antibiotics and/or ionophores. Accordingly, the present disclosure provides a method of reducing or eliminating the use of antibiotics and/or ionophores in ruminant livestock production, the method comprising feeding the ruminant livestock an animal feed comprising the composition as described herein, the nutritional supplement as described herein and/or the animal feed as described herein, wherein the animal feed fed to the ruminant livestock contains a reduced amount of antibiotic and/or ionophore as compared to standard dose rates, or the animal feed does not contain an antibiotic and/or ionophore.

By a “reduced amount” of antibiotic and/or ionophore, it is meant the animal feed comprises less than 50%, less than 40%, or less than 30%, 20%, 10% or 5% of the amount of antibiotic and/or ionophore that would typically be included and considered efficacious in an animal feed for ruminant livestock.

### Induction to Feedlot Ration

As understood by the person skilled in the art, induction is the management process when livestock arrive at a feedlot or intensive finishing system that ensures the health and welfare of the new arrivals. Induction considerations typically may include traceability, health and welfare procedures and performance management. As part of the induction process, animals should be provided with clean water and fresh hay immediately upon arrival at the feedlot. The animals may then be gradually introduced to the feedlot ration. For example, on arrival at a feedlot, lambs may be trail fed 50 g per head of feedlot ration on the morning of day 1 and trail fed 50 g per head of feedlot ration in the afternoon of day 1, with access to adlib cereal hay and clean cool water. This feedlot ration may be gradually increased over 3-5 days to about 200 g per head of feedlot ration in the morning and again in the afternoon. Around this time the animals may also be provided 50% of the feedlot ration in trays of self-feeders. By around day 7, the animals may be receiving around 350 g per head of feedlot ration AM and PM, with 75% of the feedlot ration provided in trays of self-feeders. By around day 10 to day 11, the animals may be receiving full feedlot ration while the hay is allowed to be consumed without replacement. The skilled person will be able to determine suitable protocols for other ruminant animals such as cattle.

### Preventing Ruminal Acidosis

Ruminal acidosis is increasingly recognised as a significant disorder of ruminants. This condition increases the morbidity and mortality of stock, markedly reduces weight gains in the feedlot, complicates drought feeding strategies for sheep and cattle, and is increasingly recognised in pastoral and confined dairying. It may be one of the most significant health disorder of ruminants fed on high-quality pastures and grain.

Acidosis is a pathological condition associated with the accumulation of acid or depletion of alkaline reserves in blood and body tissues, and characterised by increased hydrogen ion concentrations. Ruminal acidosis refers to a series of conditions that reflect a decrease in pH in the rumen of cattle. Rumen lactic acidosis (grain overload, grain poisoning, acute indigestion) develops in sheep and cattle that have ingested large amounts of unaccustomed feeds rich in ruminally fermentable carbohydrates.

The resulting production of large quantities of volatile fatty acids (VFA) and lactic acid decreases rumen pH to non-physiological levels, simultaneously weakening the buffering capacity of the rumen, and reduces the efficiency of rumen flora and fermentation. Lactic acidosis can cause ruminitis, metabolic acidosis, lameness, hepatic abscessation, pneumonia and death. Acidosis can be divided into two categories—clinical and sub-clinical.

Signs often associated with sub-clinical acidosis include a reduction in milk fat content, feed conversion efficiency, feed intake and decreased digestion of fibre, laminitis causing lameness, liver abscessation, scouring, and a higher incidence of left and right displacements of the abomasum. Sub-clinical acidosis often goes unrecognised and undiagnosed until significant herd involvement and obvious clinical signs are evident. At this stage, large financial losses and long-term health issues, such as a high prevalence of herd lameness, may be inevitable.

The present disclosure provides a method of reducing the risk of, or preventing, ruminal acidosis in a ruminant animal. The method comprises feeding the composition, nutritional supplement and/or animal feed as described herein to the ruminant animal. In one example, the composition, nutritional supplement and/or animal feed is fed to the ruminant animal during induction to feed lot ration in order to reduce the risk of, or prevent, ruminal acidosis. Feedlot ration may be, for example, based on grain, plus dry roughage, with an average dry matter content of around 80% to 90%.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

### EXAMPLES

### Example 1. Formulation of the Composition

The test composition was formulated to contain vitamins, trace elements, methionine, prebiotics, plant extracts, dust control and carrier. The ingredients formulated into the test compositions are provided in Table 1. The Table provides the preferred ranges of the ingredients, as well as the ingredient amounts in the test compositions used in further Examples.

TABLE 1
Amounts and acceptable ranges of ingredients in the test composition.

| Active | Preferred | | | | | | | | | | | |
|---|---|---|---|---|---|---|---|---|---|---|---|---|
| ingredient | Range | | Test A | | Test B | | Test C | | Test D | | Test E | |
| Vitamin A | 3-7 | MIU/kg | 1.67 | MIU/kg | 3.33 | MIU/kg | 3.00 | MIU/kg | 4.14 | MIU/kg | 4.17 | MIU/kg |
| Vitamin D3 | 0.2-0.6 | MIU/kg | 0.20 | MIU/kg | 0.40 | MIU/kg | 0.35 | MIU/kg | 0.41 | MIU/kg | 0.50 | MIU/kg |
| Vitamin E | 50-100 | g/kg | 66.67 | g/kg | 26.50 | g/kg | 100.00 | g/kg | 82.83 | g/kg | 83.33 | g/kg |
| Vitamin B | 6-10 | g/kg | — | | 14.00 | g/kg | 1.00 | | 8.28 g/kg | | 8.33 g/kg | |
| | | | | | | | (biotin) | | (thiamine) | | (thiamin) | |
| | | | | | | | 10.00 | | | | | |
| | | | | | | | (thiamine) | | | | | |
| | | | | | | | g/kg | | | | | |
| Copper | 8-12 | g/kg | — | | — | | 4.80 | g/kg | 11.18 | g/kg | 11.25 | g/kg |
| Cobalt | 0.05-0.2 | g/kg | 0.17 | g/kg | 0.07 | g/kg | 0.07 | g/kg | 0.11 | g/kg | 0.12 | g/kg |
| Iodine | 0.25-0.75 | g/kg | 0.17 | g/kg | 0.60 | g/kg | 0.30 | g/kg | 0.55 | g/kg | 0.56 | g/kg |
| Manganese | 6-10 | g/kg | 6.65 | g/kg | 8.0 | g/kg | 12.00 | g/kg | 8.28 | g/kg | 8.33 | g/kg |
| Selenium | 0.02-0.05 | g/kg | 0.01 | g/kg | 0.02 | g/kg | 0.03 | g/kg | 0.04 | g/kg | 0.05 | g/kg |
| Zinc | 14-18 | g/kg | 13.30 | g/kg | 16.00 | g/kg | 18.00 | g/kg | 16.56 | g/kg | 16.67 | g/kg |
| Methionine | 150-500 | g/kg | 504.00 | g/kg | 250.00 | g/kg | 420.00 | g/kg | 209.17 | g/kg | 210.42 | g/kg |
| Mannan- | 30-40 | g/kg | 35 | g/kg | 24 | g/kg | 32 g | g/k | 35.5 | g/kg | 35.5026 | g/kg |
| oligosaccharides | | | | | | | | | | | | |
| (MOS) and β- | | | | | | | | | | | | |
| (1,3 and 1,6)- | | | | | | | | | | | | |
| poly-D-glucose | | | | | | | | | | | | |
| Plant extracts | 10-60 | g/kg | 20.00 | g/kg | 40.00 | g/kg | 48.50 | g/kg | 57.98 | g/kg | 57.33 | g/kg |
| from: | | | | | | | | | | | | |
| Coriandrum | | | | | | | | | | | | |
| sativum | | | | | | | | | | | | |
| Daucus carota | | | | | | | | | | | | |
| Myristica | | | | | | | | | | | | |
| fragrans | | | | | | | | | | | | |
| Dust control | 5-10 | g/kg | 10.0 | g/kg | 8.0 | g/kg | 8.0 | g/kg | 9.0 | g/kg | 9.0 | g/kg |
| Carrier | 50-100 | g/kg | 27 | g/kg | 100 | g/kg | 80 | g/kg | 100 | g/kg | 90 | g/kg |

### Example 2. Commercial Cattle Feedlot—60 Day Induction Trial

Farm trials with test composition D as described herein were performed in a commercial cattle feedlot. The trial consisted of three treatments: i) 1 pen with 70 head, fed with test diet containing 5% of the test composition; ii) Diet 2 consisting of an alternate product which included ionophores; and iii) diet 3 consisting of another alternate product which included ionophores. The three treatments are outlined in Table 2, and the results of the trial are provided in Table 3.

TABLE 2
Diets used in the feeding trial.

| Feed Ingredient | Test Diet | Diet 2 | Diet 3 |
|---|---|---|---|
| Wheat | 73.84% | 71.34% | 74.34% |
| Barley straw | 15% | 15% | 15% |
| Urea | 0.16% | 0.16% | 0.16% |
| Faba beans | 6% | 6% | 6% |
| Concentrate | 5% | 5% | 5% |
| Oil | 0% | 2% | 2% |
| $/Tonne total | $275.17 | $289.15 | $260.26 |

TABLE 3
Results after 60 days from induction

| Metric | Test Diet | | Diet 2 | | Diet 3 | |
|---|---|---|---|---|---|---|
| Intake | 12.42 | kg/hd/day | 13.1 | kg/hd/day | 13.5 | kg/hd/day |
| Average Daily | 2.18 | kg/hd/day | 1.98 | kg/hd/day | 1.9 | kg/hd/day |
| Gain (ADG) | | | | | | |
| Feed | 5.7:1 As fed | | 6.6:1 As fed | | 7.1:1 | |
| Conversion | | | | | | |
| Ratio (FCR) | | | | | | |
| Total Gain | 130.8 | kg | 118.8 | kg | 114 | kg LWG |
| COG | $1.56 | kg LWG | $1.90 | kg LWG | $1.84 | kg LWG |

| | | | |
|---|---|---|---|
| Value gained at | $392.40/hd | $356.40/hd | $342.00/hd |
| $3.00 kg LW | | | |
| TOTAL feed | $204.04/hd | $225.72/hd | $209.76/hd |
| cost | | | |
| Margin | $188.36/hd | $130.68/hd | $132.24/hd |

As indicated in Table 3, the treatment group that received the test composition achieved an increase in economic return of approximately 44%, this was calculated on improved feed utilisation, improved feed conversion, improved average daily gain, overall improved total kg gain and reduced cost of gain based on ration costs.

### Example 3. Intensive Cattle Feeding Trials

Several compositions comprising ingredient concentrations as specified in Table 1 were evaluated in cattle feed trials at several locations. The composition of the basal diet fed to the cattle remained relatively consistent across the trials. The composition of the base diet is provided in Table 4.

TABLE 4
Base diet

| Ingredient | Inclusion |
|---|---|
| Cereal grain (wheat or barley) | 69.64% |
| Cereal hay (wheat or barley) | 17% |
| Pulse (Faba beans or lupins) | 8% |
| Urea | 0.16% |
| Premix | 5% |

Historical long term average on the feed efficiency has hovered around 6.8-7:1 as feed. This means that it takes around 6.8 to 7 kg of the above diet to gain 1 kg of live weight. This feed efficiency then represents an average daily gain of 1.7-1.8 kg per head per day. The results provided in Table 5, below, are from different locations over a 5 month period. The data set represents approximately 5000 cattle.

TABLE 5
Average daily gain across locations, including differentials
of methane emissions, water use and nitrous oxide emissions.

| | Feed | | | | | |
|---|---|---|---|---|---|---|
| | Efficiency | Average | | Methane | Water Use | Nitrous Oxide |
| | as fed, kg | Daily | | Emissions | litres/live | Emissions |
| | consumed | Gain | | kg/liveweight | weight | kg/liveweight |
| | per kg gain | Kg/head/day | DMI/Day | gain | gain | gain |
| C1 | 5.50 | 2.24 | 12.32 | 118.80 | 17.86 | 56.10 |
| C2 | 5.50 | 2.24 | 12.32 | 118.80 | 17.86 | 56.10 |
| C3 | 5.70 | 2.18 | 12.43 | 123.12 | 18.35 | 58.14 |
| C4 | 5.80 | 2.10 | 12.18 | 125.28 | 19.05 | 59.16 |
| C5 | 5.40 | 2.17 | 11.72 | 116.64 | 18.43 | 55.08 |
| C6 | 4.90 | 2.60 | 12.74 | 105.84 | 15.38 | 49.98 |
| Ave1 | 6.80 | 1.80 | 12.24 | 146.88 | 22.22 | 69.36 |
| Ave2 | 7.00 | 1.70 | 11.90 | 151.20 | 23.53 | 71.40 |

C1-C6 represent results with test compositions at different locations; Ave1 and Ave2 = Industry Averages. C1-C6 = test composition 4, C5 and C6 = test composition D.

### Example 4. Intensive Sheep Feeding Trial

The composition as described herein were evaluated in sheep feed trials at several locations. The composition of the basal diet fed to the sheep remained relatively consistent across the trials. The composition of the base diet is provided in Table 6.

TABLE 6
Composition of the base diet

| Ingredient | Inclusion |
|---|---|
| Cereal grain (wheat or barley) | 75% |
| Pulse (Faba beans or lupins) | 20% |
| Premix | 5% |

Historical long term average on the feed efficiency has hovered around 4:1 to 4.5:1 as feed. This means that it takes around 4 kg to 4.5 kg of the above diet to gain 1 kg of live weight. This feed efficiency then represents an average daily gain of 260 g to 280 g per head per day. The results from different locations over a 5 month period are provided in Table 7.

TABLE 7
Average daily gain across locations, including differentials
of methane emissions, water use and nitrous oxide emissions.

| | Feed | | | | | |
|---|---|---|---|---|---|---|
| | Efficiency | Average | | Methane | Water Use | Nitrous Oxide |
| | as fed/kg | Daily | | Emissions | litres/kg | Emissions |
| | liveweight | Gain | | kg/liveweight | live weight | kg/liveweight |
| | gain | kg/hd/day | DMI/Day | gain | gain | gain |
| S1 | 4.00 | 0.3 | 1.20 | 67.20 | 10.00 | 180.00 |
| S2 | 3.20 | 0.375 | 1.20 | 53.76 | 8.00 | 144.00 |
| S3 | 3.10 | 0.387 | 1.20 | 52.08 | 7.75 | 139.50 |
| S4 | 3.50 | 0.342 | 1.20 | 58.80 | 8.77 | 157.50 |
| S5* | 2.80 | 0.27 | 0.76 | 47.04 | 11.11 | 126.00 |
| S6 | 3.40 | 0.352 | 1.20 | 57.12 | 8.52 | 153.00 |
| Ave1 | 4.50 | 0.26 | 1.17 | 75.60 | 11.54 | 202.50 |
| Ave2 | 4.00 | 0.28 | 1.12 | 67.20 | 10.71 | 180.00 |

S1-S6 represent results with test compositions at different locations; Ave1 and Ave2 = Industry Averages. The data set represents approximately 15,000 lambs. S1-S3 = test composition A; S4-S6 = test composition B.

*These animals were intensively fed effectively from birth. They were weaned at 9-12 kg (4-6 weeks of age) and intensively fed until they were marketed at 51 kg at 180 days of age.

### Example 5. Evaluation of Composition in Sheep Pellet Feeding Trial

The key metrics measured in this trial include: average daily gain, feed efficiency, mortality, morbidity (Pull rate), and average faecal score.

The following health treatments were administered prior to commencement of the feed trial: Vitamin AD & E, 1 ml intramuscular; clostridia vaccine (6 in 1 SB12 1 ml, subcutaneous); multi-group internal parasite treatment.

The diet fed to sheep in the trial comprised: 75% cereal grain (wheat or barley); 20% lupins; and 5% test composition.

Lambs were weighed and grouped into weight classes with no greater than a 5 kg variation between individuals. Animals were randomised for use in both the treatment and control groups, with no greater than 250 lambs per treatment (test composition A).

Each animal was allocated a minimum of 3 m² pen space, a minimum of 50 mm feed trough space, and a minimum of 20 mm water trough space.

The trial data is provided in Table 8.

TABLE 8
Trial data.

| No Head | 250 (standard commercial feedlot size) |
|---|---|
| Weight In | 25 |
| Weight Out | 45 |
| Total Weight | 20 |

| | Control | | Test | | | | |
|---|---|---|---|---|---|---|---|
| | Per | | Per | | Reductions | | |
| | head | Total | head | Total | in Total Use | Measure | % |
| Feed ration | 1.2 | | 1.2 | | | | |
| kg/day | | | | | | | |
| FCR | 4.5 | | 3.5 | | | | |
| Morbidity | 4.0% | | 2.0% | | | | |
| Total Days on | 75 | | 58 | | | | |
| Feed | | | | | | | |
| Total Water Use | 225 | 56,250 | 175 | 43,750 | 12,500.00 | Litres | 22% |
| (litres) | | | | | | | |
| Total Feed Use | 90 | 22.500 | 70 | 17,500 | 5.00 | Tonnes | 22% |
| (kg) | | | | | | | |
| Total Methane | 2 | 378 | 1 | 294 | 0.08 | Tonnes | 22% |
| emissions kg/head | | | | | | | |
| Total Nitrous | 4 | 1,013 | 3 | 788 | 0.23 | Tonnes | 22% |
| oxide emissions | | | | | | | |
| kg/head | | | | | | | |
| Total Antibiotic | 0.02 | 5.63 | | | 0.01 | Tonnes | 100% |
| kg head | | | | | | | |

### Example 6. Reduction of Lactic Acidosis in Feedlot Cattle

10 Angus cattle were fed either a standard feedlot finisher ration (“Control Diet”) based on 75% rolled barley (Table 1) or the same diet to which the test composition of the present disclosure had been included be added with 5 cattle/diet. The control diet contained 22-25 ppm Monensin as industry standard practice, whereas the test composition contained no Monensin.

Cattle were offered a constant quantity of dry matter (equivalent to 2% average body weight) and progressively adjusted to diets for 20 days, with feed being offered once per day according to Table 9.

TABLE 9
Ingredient composition (test composition E) of the feedlot rations (Starter,
Transition rations [T1, T2] and Finisher) with dietary acclimation
schedule used in the trial. It is expected that test composition would be
added at a constant fixed % throughout all these transitions from the beginning.

| | | | Cotton- | Mill | Wheat&oaten | Dry | Vegetable | |
|---|---|---|---|---|---|---|---|---|
| Ration | Barley | Test | seed | run | chaff | Suppl. | oil | Molasses |
| Starter | 45.7% | 5% | 9.7% | 10% | 23% | 2.6% | 0% | 4.0% |
| T1 | 56.9% | 5% | 8.7% | 6.7% | 15.9% | 2.6% | 0.9% | 3.3% |
| T2 | 67.9% | 5% | 7.7% | 3.4% | 9.0% | 2.6% | 1.8% | 2.6% |
| Finisher | 78.7% | 5% | 6.7% | 0% | 2.2% | 2.6% | 2.8% | 2.0% |

All animals contain an intra-ruminal pH measuring device (indwelling Smaxtek sensor) which wirelessly feeds data to a logger where real time pH fluctuations can be monitored.

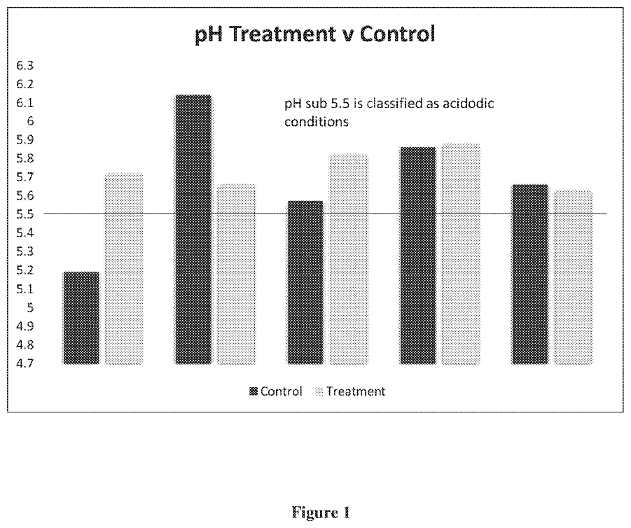

The results for intra-ruminal pH measurements in the treatment versus control groups are provided in Table 10 and in FIG. 1. The average intra-ruminal pH in the control group was 5.68 versus 5.74 in the treatment group. In addition, none of the treatment animals had an intra-ruminal pH classified as acidotic, whereas one of the control animals entered lactic acidosis, with a second control animal close to the sub pH 5.5 threshold for acidotic conditions.

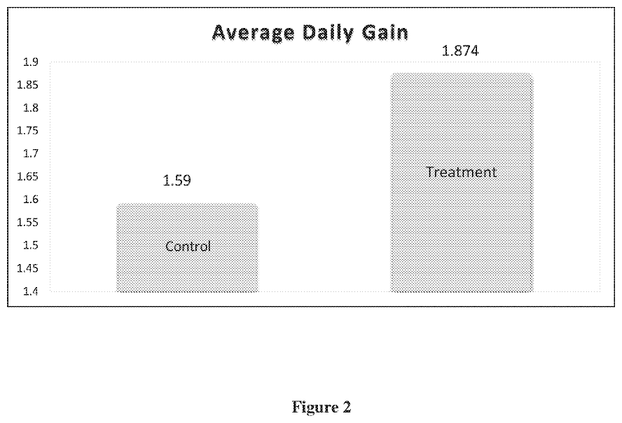

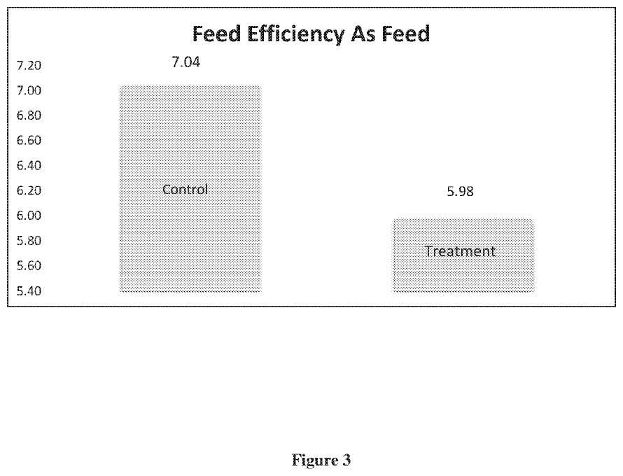

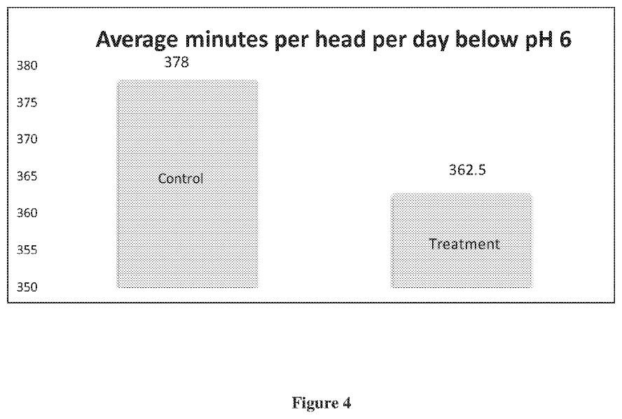

FIG. 2 shows that the average daily gain for animals in the treatment group was greater than for the control group. As shown in FIG. 3, animals in the treatment group exhibited greater feed efficiency as compared to the control group, and FIG. 4 shows that the rumens of animals in the treatment group spent fewer minutes per day below pH 6 when compared to the control group.

1. A composition for ruminant animals comprising:
i) at least one vitamin selected from Vitamin A, Vitamin D3, B Group Vitamin B and Vitamin E;
ii) at least one trace element selected from Cobalt, Iodine, Manganese, Selenium and Zinc;
iii) at least one sulphur containing amino acid selected from methionine, methionine hydroxy analog, lysine, homocysteine and cysteine;
iv) at least one prebiotic selected from an oligosaccharide prebiotic and a polysaccharide prebiotic; and
v) at least one plant extract.

2. The composition of claim 1, wherein the at least one plant extract is selected from Coriandum sativum extract, Daucus carota extract, Myristica fragrans extract, Aniba rosaeodora extract, Apium graveolens extract, Boswellia carterii extract, Cananga odorata extract, Cedrus atlantica extract, Citrus aurantifolia extract, Citrus aurantium extract, Citrus aurantium var. bergamia extract, Citrus limon extract, Citrus x paradisi extract, Citrus reticulata var. madurensis extract, Commiphora myrrha extract, Coriandrum sativum extract, Cucurbita pepo extract, Cupressus sempervirens extract, Cymbopogon citratus extract, Cymbopogon martini extract, Cymbopogon nardus extract, Daucus carota extract, Eucalyptus polybractea extract, Foeniculum vulgare extract, Gaultheria procumbens extract, Juniperus communis extract, Lavandula angustifolia extract, Macadamia integrifolia extract, Melaleuca alternifolia extract, Melaleuca cajuputi extract, Melaleuca quinquenervia extract, Mentha x piperita extract, Mentha spicata extract, Ocimum basilicum extract, Oenothera biennis extract, Origanum majorana extract, Origanum vulgare extract, Pelargonium graveolens extract, Pimpinella anisum extract, Pimenta racemose extract, Pinus sylvestris extract, Piper nigrum extract, Pogostemon patchouli extract, Prunus armeniaca extract, Prunus dulcis extract, Rosmarinus officinalis extract, Salvia officinalis extract, Salvia sclarea extract, Santalum album extract, Syzygium aromaticum extract, Thymus vulgaris extract, and Vetiveria zizanioides extract.

3. The composition of claim 1 or claim 2, wherein the composition comprises at least three plant extracts.

4. The method of any one of claims 1 to 3, wherein the plant extract is an essential oil.

5. The composition of any one of claims 1 to 4, further comprising a dust control agent and/or a carrier.

6. The composition of claim 5, wherein the carrier is selected from wheat pollard and rice hull.

7. The composition of any one of claims 1 to 6, wherein the composition comprises 3-7 MIU/kg Vitamin A, 0.2-0.6 MIU/kg Vitamin D3, 50-100 g/kg Vitamin E, and/or 6-10 g/kg Vitamin B1.

8. The composition of any one of claims 1 to 7, wherein the composition comprises 8-12 g/kg Copper, 0.05-0.2 g/kg Cobalt, 0.25-0.75 g/kg Iodine, 6-10 g/kg Manganese, 0.02-0.05 g/kg Selenium, and/or 14-18 g/kg Zinc.

9. The composition of any one of claims 1 to 8, wherein the composition comprises 150-500 g/kg Methionine or Methionine hydroxy analog.

10. The composition of any one of claims 1 to 9, wherein the composition comprises 30-40 g/kg mannan-oligosaccharides (MOS) and β-(1,3 and 1,6)-poly-D-glucose.

11. The composition of any one of claims 1 to 10, wherein the composition comprises Vitamin A, Vitamin D3, Vitamin B1, Vitamin E, Copper, Cobalt, Iodine, Manganese, Selenium, Zinc, Methionine, mannan-oligosaccharides (MOS) and β-(1,3 and 1,6)-poly-D-glucose

12. The composition of any one of claims 1 to 11, wherein the composition comprises about 10-60 g/kg of Coriandum sativum extract, Daucus carota extract and/or Myristica fragrans extract.

13. The composition of any one of claims 1 to 12, wherein the composition is prepared in the form of a liquid, prill, dry lick, pellets or meal.

14. The composition of any one of claims 1 to 13, wherein the composition does not contain antibiotics and/or ionophores.

15. A nutritional supplement for feeding to ruminant animals comprising the composition of any one of claims 1 to 14.

16. The nutritional supplement of claim 15, wherein the supplement comprises one or more ingredients selected from magnesium oxide, potassium chloride, sulphur, sodium chloride, lime, canola oil, canola meal, wheat, and rice hull.

17. The composition of any of claims 1 to 14 or the nutritional supplement of claim 15 or claim 16, wherein the composition or supplement comprises one or more of a protein source, roughage, a buffer, and/or additional minerals.

18. The composition of any one of claims 1 to 14 or the nutritional supplement of claim 15 or claim 16, wherein the composition is for feeding to ruminant animals in a feedlot, ruminant animals receiving intensive finishing nutrition and/or supplemental feeding in extensive grazing.

19. An animal feed comprising the composition of any one of claim 1 to 14, 17 or 18, or the nutritional supplement of any one of claims 15 to 18.

20. The animal feed of claim 19, wherein the feed comprises the composition or nutritional supplement mixed with cereal grain rations and/or provided as part of dietary supplementation.

21. A method of improving the feed conversion, feed efficiency, resource utilisation and/or water utilization of a ruminant animal, the method comprising feeding the composition of any one of claim 1 to 14, 17 or 18, the nutritional supplement of any one of claims 15 to 18, or the animal feed of claim 19 or claim 20 to the ruminant animal.

22. A method of reducing ruminant animal methane and/or nitrous oxide emissions, the method comprising feeding the composition of any one of claim 1 to 14, 17 or 18, the nutritional supplement of any one of claims 15 to 18, or the animal feed of claim 19 or claim 20 to the ruminant animal.

23. A method of inducing satiety in a ruminant animal, the method comprising feeding the composition of any one of claim 1 to 14, 17 or 18, the nutritional supplement of any one of claims 15 to 18, or the animal feed of claim 19 or claim 20 to the ruminant animal.

24. A method of controlling the food intake of a ruminant animal, the method comprising feeding the composition of any one of claim 1 to 14, 17 or 18, the nutritional supplement of any one of claims 15 to 18, or the animal feed of claim 19 or claim 20 to the ruminant animal.

25. A method of improving ammonia retention in the rumen of a ruminant animal, the method comprising feeding the composition of any one of claim 1 to 14, 17 or 18, the nutritional supplement of any one of claims 15 to 18, or the animal feed of claim 19 or claim 20 to the ruminant animal.

26. A method of reducing the risk of a ruminant animal developing ruminal acidosis, the method comprising feeding the composition of any one of claim 1 to 14, 17 or 18, the nutritional supplement of any one of claims 15 to 18, or the animal feed of claim 19 or claim 20 to the ruminant animal.

27. A method of preventing ruminal acidosis in a ruminant animal, the method comprising feeding the composition of any one of claim 1 to 14, 17 or 18, the nutritional supplement of any one of claims 15 to 18, or the animal feed of claim 19 or claim 20 to the ruminant animal.

28. A method of reducing or eliminating the use of antibiotics and/or ionophores in ruminant livestock production, the method comprising feeding the composition of any one of claim 1 to 14, 17 or 18, the nutritional supplement of any one of claims 15 to 18, or the animal feed of claim 19 or claim 20 to the ruminant livestock.

29. The method of any one of claims 21 to 28, wherein the method comprises formulating the composition as a mineral concentrate, liquid, extrusion, or prill, and feeding the composition to the ruminant animal at a rate of about 0.5 to about 3.0 grams per kg dry matter intake per day.

30. The method of claim 29, wherein the ruminant animal is selected from cattle, sheep, goats and deer.

31. The method of claim 30, wherein the ruminant animal is a sheep and the method comprises feeding the sheep about 0.5 to about 3 grams per kg dry matter intake per day.

32. The method of claim 30, wherein the ruminant animal is cattle and he method comprises feeding the cattle about 0.5 to about 3 grams per kg dry matter intake per day.

33. The method of any one of claims 21 to 28, wherein the method comprises formulating the composition with a bulking agent to form a mineral lick or pellet, and feeding the composition to the ruminant animal at a rate of about 20 grams to about 650 grams per head per day.

34. The method of claim 33, wherein the ruminant animal is selected from cattle and sheep.

35. The method of claim 34, wherein the ruminant animal is a sheep and the method comprises feeding the sheep about 0.5 to about 3 grams per kg dry matter intake per day.

36. The method of claim 34, wherein the ruminant animal is cattle and the method comprises feeding the sheep about 0.5 to about 3 grams per kg dry matter intake per day.

37. Use of the composition of any one of claim 1 to 14, 17 or 18, or the nutritional supplement of any one of claims 15 to 18 as a supplement for addition to livestock full feed ration.

38. Use of the composition of any one of claim 1 to 14, 17 or 18, or the nutritional supplement of any one of claims 15 to 18 or the animal feed of any one of claim 19 or 20 for improving the feed conversion, feed efficiency, resource utilisation and/or water utilization of a ruminant animal.

39. Use of the composition of any one of claim 1 to 14, 17 or 18, or the nutritional supplement of any one of claims 15 to 18 or the animal feed of any one of claim 19 or 20 for reducing ruminant animal methane and/or nitrous oxide emissions, for inducing satiety in a ruminant animal, for controlling the food intake of a ruminant animal, and/or for improving ammonia retention in the rumen of a ruminant animal.
